(19) United States
(12) Patent Application Publication
(10) Pub. No.: US 2025/0100390 A1
(43) Pub. Date: Mar. 27, 2025

(54) VEHICLE BRAKING CONTROL SYSTEM

(71) Applicant: Faiveley Transport Italia S.P.A., Piossasco (Torino) (IT)

(72) Inventor: Paolo Pietro Piccione, Torino (IT)

(73) Assignee: Faiveley Transport Italia S.P.A., Piossasco (Torino) (IT)

(21) Appl. No.: 18/972,614

(22) Filed: Dec. 6, 2024

Related U.S. Application Data
(63) Continuation-in-part of application No. PCT/IB2023/055798, filed on Jun. 6, 2023.

(30) Foreign Application Priority Data
Jun. 7, 2022 (IT) 102022000012023

(51) Int. Cl. B60L 7/26; B60L 3/00

(52) U.S. Cl. CPC B60L 7/26; B60L 3/0076; B60L 2240/14

(57) ABSTRACT

A braking control system for a vehicle system includes a first control circuit configured to, responsive to receiving an emergency braking request signal indicative of a request for the application of an emergency braking force having an emergency braking force target value, control an electrodynamic braking system of the vehicle system for the generation of an emergency electrodynamic braking force, and to receive an electrodynamic braking force signal indicative of an electrodynamic braking force value applied by the electrodynamic braking system, and, responsive to when the electrodynamic braking force signal indicates an electrodynamic braking force value less than the emergency braking force target value, control activation of a pneumatic braking system of the vehicle system to generate an additional pneumatic braking force configured to compensate for the difference in braking force between the emergency braking force target value and the electrodynamic braking force value.

### CROSS-REFERENCE TO RELATED APPLICATION

This application is a continuation-in-part of International Application No. PCT/IB2023/055798 filed 6 Jun. 2023, which claims priority to IT102022000012023A filed 7 Jun. 2022, both incorporated by reference herein.

### BACKGROUND

### Technical Field

Embodiments of the invention relate to braking control systems for vehicles.

### Discussion of Art

In some railway vehicle systems (e.g., a train having one or more locomotives and one or more rail cars), whether mass transit, regional, or high-speed trains, emergency braking is achieved by means of a pneumatic braking system which, using compressed air acting on pistons housed in brake cylinders, applies a braking force. The braking force is provided by friction pads (i.e., brake shoes or pads), driven by the aforethe pneumatic pistons to press against wheels of the vehicle system, discs attached to the wheels W or axles, or the like. The braking force is thus applied through the use of friction elements, which use the frictional force between surfaces to ensure the stopping of the railway vehicle system.

It is therefore known that emergency braking is ensured through the wear of specific friction materials. However, the wear and tear of specific friction materials, which is necessary in order to ensure emergency braking at a high safety integrity level (Safety Integrity Level=4 according to the European standard EN 50126), has a number of drawbacks. For example, friction braking may involve emission of particulate matter into the air, represented by particles removed from friction materials in contact during emergency braking. Further, friction braking involves wear of both the aforethe brake pads and the aforethe contact surfaces (discs or wheels), and there is an inherent inability to reuse the energy produced during the friction of the aforethe materials, which is entirely dissipated in the form of heat.

Another drawback is the size and/or total number of brake cylinders, and related brake pads, within a railway vehicle system. In particular, due to the high energies required to bring the vehicle to a stop during emergency braking, it is necessary to size the braking system with a certain number of specific brake cylinders and related brake pads. This has a negative impact on the costs of the braking system, installation costs, and maintenance costs.

As shown in FIG. 1, some railway vehicle systems include an electrodynamic braking system 100, which relies on the use of magnetic fields to apply a braking force to the vehicle system. Such systems do not utilize any friction material and therefore do not produce the aforethe particulate matter. Magnetic fields may, for example, derive from electric motors 102 associated with respective vehicle wheels W and be used in braking to generate an electrodynamic braking force. Additionally, the use of the electrodynamic braking system 100 allows for the recovery of energy that would otherwise be dissipated by the aforethe pneumatic system.

It is also known, however, that the current electrodynamic braking systems are typically systems with a Safety Integrity Level (SIL according to EN 50126) lower than the level required for an emergency function. Therefore, electrodynamic braking systems are generally not used during emergency braking. For example, as shown in FIG. 1, in known braking systems, there is a connection device 104 interposed between an electrical power system 106 and the electrodynamic braking system 100. The opening and closing of the connection device may be controlled by a control circuit 108, such as, for example, a control circuit for vehicle management. This control circuit 108 may keep the connection device 104 in its closed condition when it is necessary to utilize the electrodynamic braking system during service braking. Otherwise, during emergency braking, this control circuit 108 may bypass the electrodynamic braking system (having a low degree of safety integrity) by opening the connection device 104 and performing emergency braking through the pneumatic braking system having a sufficiently high safety integrity level.

One known solution to the aforesaid problem involves a series of modifications to the current design of electrodynamic braking systems aimed at raising the safety integrity level. Given the complexity and cost of the modifications, however, the pneumatic braking system remains to date the most widely used system during an emergency braking.

### BRIEF DESCRIPTION

An embodiment of a braking control system for a vehicle system includes a first control circuit configured to control an electrodynamic braking system of the vehicle system for the generation of an emergency electrodynamic braking force, responsive to receiving an emergency braking request signal indicative of a request for the application of an emergency braking force having an emergency braking force target value. The first control circuit is further configured to receive an electrodynamic braking force signal indicative of an electrodynamic braking force value applied by the electrodynamic braking system. The first control circuit is further configured, responsive to when the electrodynamic braking force signal indicates an electrodynamic braking force value less than the emergency braking force target value, to control activation of a pneumatic braking system of the vehicle system to generate an additional pneumatic braking force configured to compensate for the difference in braking force between the emergency braking force target value and the electrodynamic braking force value.

### BRIEF DESCRIPTION OF THE DRAWINGS

The functional and structural features of some embodiments of a braking control system will now be described. Reference is made to the accompanying drawings, wherein:

FIG. 1 illustrates a braking system according to the prior art;

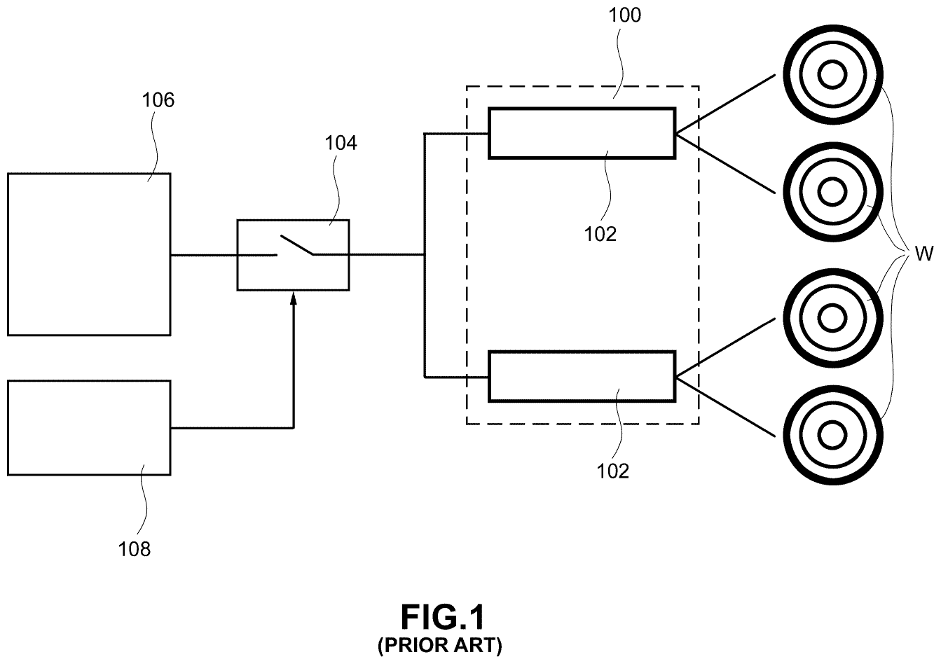

FIG. 2 illustrates a braking control system according to an embodiment of the invention;

FIG. 3 illustrates a further embodiment of a braking control system according to the invention;

FIG. 4 illustrates a still further embodiment of a braking control system according to the invention; and

FIG. 5 illustrates a still further embodiment of a braking control system according to the invention.

### DETAILED DESCRIPTION

An embodiment of a braking control system for a vehicle system includes a first control circuit. The vehicle system may include one vehicle by itself, or plural vehicles coupled to one another for travel together along a route. One example is a railway vehicle system having plural rail vehicles coupled together to travel along a track. The railway vehicle system may include one or more locomotives (e.g., having fuel engines that generate electricity to power traction motors, or batteries that provide electrical power for powering traction motors, or both, or other sources of electrical power such as fuel cells) and one or more rail cars (such as passenger cars or freight cars), typically lacking their own propulsion means, coupled to the locomotive(s), such that the locomotive(s) pull or push the rail cars along the tracks. The first control circuit is configured for operable connection to the vehicle system, e.g., the control circuit is shaped and sized for mechanical connection to a support structure (e.g., frame or compartment) of a vehicle of the vehicle system, and for electrical connection to one or more electrical systems of the vehicle including operating on electrical power provided by the vehicle. The first control circuit is further configured to control an electrodynamic braking system of the vehicle system for the generation of an emergency electrodynamic braking force, responsive to receiving an emergency braking request signal indicative of a request for the application of an emergency braking force having an emergency braking force target value. The first control circuit is further configured to receive an electrodynamic braking force signal indicative of an electrodynamic braking force value applied by the electrodynamic braking system. The first control circuit is further configured, responsive to when the electrodynamic braking force signal indicates an electrodynamic braking force value less than the emergency braking force target value, to control activation of a pneumatic braking system of the vehicle system to generate an additional pneumatic braking force configured to compensate for the difference in braking force between the emergency braking force target value and the electrodynamic braking force value.

The first control circuit may be configured to control the electrodynamic braking system (to generate an electrodynamic braking force) by one or more of: generating one or more control signals configured to control one or more traction motor control circuits of the vehicle system so that one or more traction motors of the vehicle system operate as generators, instead of as motors, in a dynamic or regenerative braking mode of operation; generating one or more control signals configured to control a connection device (e.g., relay or solid-state device or other switch) to enable a flow of electrical power generated by one or more traction motors of the vehicle system (operating as generators in a dynamic or regenerative mode of operation) to an electrical power system of the vehicle system, e.g., an energy storage device for storing the electrical power, and/or a resistive grid for dissipating the electrical power as waste heat; and/or generating one or more control signals configured to control a connection device (e.g., relay or solid-state device or other switch) to enable a flow of electrical power from an electrical power system of the vehicle system to the electrodynamic braking system, in situations where the electrodynamic braking system requires the provision of electrical power to generate an electrodynamic braking force, e.g., where the electrodynamic braking system includes an eddy current brake, a magnetic track brake, or the like, and/or from the perspective of providing electrical power to power motor control circuits to switch traction motors for dynamic or regenerative braking. For example, the first control circuit may be configured to control the electrodynamic braking system for the generation of the emergency electrodynamic braking force through the electrodynamic braking system, responsive to receiving the emergency braking request signal, by switching the connection device from a second condition, configured to prevent the flow of electrical energy between an electrical power system of the vehicle system and the electrodynamic braking system, to a first condition configured to enable the flow of the electrical energy between the electrical power system and the electrodynamic braking system.

In another embodiment, the braking control system may further include a second control circuit configured for operable connection to the vehicle system, e.g., to the same or different vehicle than the first control circuit. (In one aspect, the first and second control circuits may be different control circuits onboard the same vehicle of the vehicle. system.) The second control circuit is configured to control deactivation of the electrodynamic braking system from emergency braking, responsive to when the second control circuit determines that there is a failure of the electrodynamic braking system; and/or when the second control circuit determines that there is a failure of an electrical power system connected to the electrodynamic braking system. The second control circuit may be configured to control deactivation of the electrodynamic braking system (for halting or preventing use of the electrodynamic braking system for emergency braking) by one or more of: generating one or more control signals configured to control one or more traction motor control circuits of the vehicle system so that one or more traction motors of the vehicle system operate as motors, and not as generators; generating one or more control signals configured to control a connection device to prevent a flow of electrical power generated by one or more traction motors of the vehicle system (operating as generators in a dynamic or regenerative mode of operation) to an electrical power system of the vehicle system, or to electrically disconnect the traction motors; and/or generating one or more control signals configured to control a connection device to disable a flow of electrical power from an electrical power system of the vehicle system to the electrodynamic braking system, in situations where the electrodynamic braking system requires the provision of electrical power to generate an electrodynamic braking force.

In another embodiment, the first control circuit is further configured, during the application of the emergency electrodynamic braking force by the electrodynamic braking system, to determine a vehicle deceleration value, and, responsive to when the determined vehicle deceleration value is less than a target vehicle deceleration value, control deactivation of the electrodynamic braking system from emergency braking. The first control circuit is further configured to activate the pneumatic braking system for the generation of an emergency pneumatic braking force having a value equal to or greater than the emergency braking force target value. The first control circuit may be configured to control deactivation of the electrodynamic braking system from emergency braking (i.e., to halt or prevent use of the electrodynamic braking system for emergency braking) by one or more of: generating one or more control signals configured to control one or more traction motor control circuits of the vehicle system so that one or more traction motors of the vehicle system operate as motors, and not as generators; generating one or more control signals configured to control a connection device to prevent a flow of electrical power generated by one or more traction motors of the vehicle system (operating as generators in a dynamic or regenerative mode of operation) to an electrical power system of the vehicle system, or to electrically disconnect the traction motors; and/or generating one or more control signals configured to control a connection device to disable a flow of electrical power from an electrical power system of the vehicle system to the electrodynamic braking system, in situations where the electrodynamic braking system requires the provision of electrical power to generate an electrodynamic braking force.

In another embodiment, the first control circuit is configured to transmit to the electrodynamic braking system a requested emergency electrodynamic braking force signal whose value is indicative of the emergency electrodynamic braking force value to be applied by the electrodynamic braking system. The first control circuit is configured to determine the value of the requested emergency electrodynamic braking force signal according to the emergency braking force target value and/or a maximum electrodynamic braking force value applicable by the electrodynamic braking system. The maximum applicable electrodynamic braking force value may be determined according to a braking characteristic of the electrodynamic braking system that relates a vehicle travel speed and the maximum electrodynamic braking force value applicable by the electrodynamic braking system.

In another embodiment, a braking control system for a vehicle system includes a first control circuit and a second control circuit both configured for operable connection to the vehicle system. The vehicle system may include one vehicle by itself, or plural vehicles coupled to one another for travel together along a route. One example is a railway vehicle system having plural rail vehicles coupled together to travel along a track. The railway vehicle system may include one or more locomotives (e.g., having fuel engines that generate electricity to power traction motors, or batteries that provide electrical power for powering traction motors, or both, or other sources of electrical power such as fuel cells) and one or more rail cars (such as passenger cars or freight cars), typically lacking their own propulsion means, coupled to the locomotive(s), such that the locomotive(s) pull or push the rail cars along the tracks. The first control circuit and the second control circuit are configured for operable connection to the vehicle system, e.g., the control circuits are shaped and sized for mechanical connection to a support structure (e.g., frame or compartment) of a vehicle of the vehicle system, and for electrical connection to one or more electrical systems of the vehicle including operating on electrical power provided by the vehicle. The first control circuit and the second control circuit may be coupled to the same vehicle in the vehicle system, or to different vehicles in the vehicle system.

The second control circuit is further configured to receive an emergency braking request signal indicative of a request for the application of an emergency braking force having an emergency braking force target value, receive an electrodynamic braking force signal indicative of an electrodynamic braking force value applied by an electrodynamic braking system of the vehicle system, and determine an additional pneumatic braking force value necessary to compensate for a difference between the emergency braking force target value and the applied electrodynamic braking force value indicated by the electrodynamic braking force signal. The second control circuit is further configured to transmit to the first control circuit an additional pneumatic braking force signal indicative of the determined additional pneumatic braking force value. The first control circuit is further configured, responsive to receiving the emergency braking request signal indicative of the request for the application of the emergency braking force having the emergency braking force target value, to control the electrodynamic braking system for the generation of an emergency electrodynamic braking force through the electrodynamic braking system, and to receive the additional pneumatic braking force signal from the second control circuit, and to control a pneumatic braking system of the vehicle system to generate a pneumatic braking force having the additional pneumatic braking force value indicated by the additional pneumatic braking force signal.

In another embodiment, a braking control system for a vehicle system includes a first control circuit configured for operable connection to the vehicle system. The first control circuit is further configured, responsive to when the first control circuit receives an emergency braking request signal indicative of a request for the application of an emergency braking force having an emergency braking force target value, to switch a connection device of the vehicle system (e.g., relay, sold-state device, or other switch) into a first condition configured to enable the flow of electrical energy between an electrical power system and an electrodynamic braking system of the vehicle system, for the generation of an electrodynamic emergency braking force through the electrodynamic braking system. (As an example, in the first condition electrical power generated by traction motors of the electrodynamic braking system, controlled to act as generators in a dynamic or regenerative braking mode of operation, may be routed to an energy storage device or to a resistive grid for dissipation as waste heat. As another example, the electrodynamic braking system requires electrical power to generate an electrodynamic emergency braking force, and in the first condition electrical power may be provided from the electrical power system to the electrodynamic braking system.) The first control circuit is further configured, during the application of the emergency electrodynamic braking force by the electrodynamic braking system, to determine a vehicle deceleration value. The first control circuit is further configured, responsive to the determined vehicle deceleration value being less than a vehicle deceleration target value, to switch the connection device into a second condition configured to prevent the flow of electrical energy between the electrical power system and the electrodynamic braking system. The first control circuit is further configured to activate a pneumatic braking system of the vehicle system for the generation of an emergency pneumatic braking force having a value equal to or greater than the emergency braking force target value.

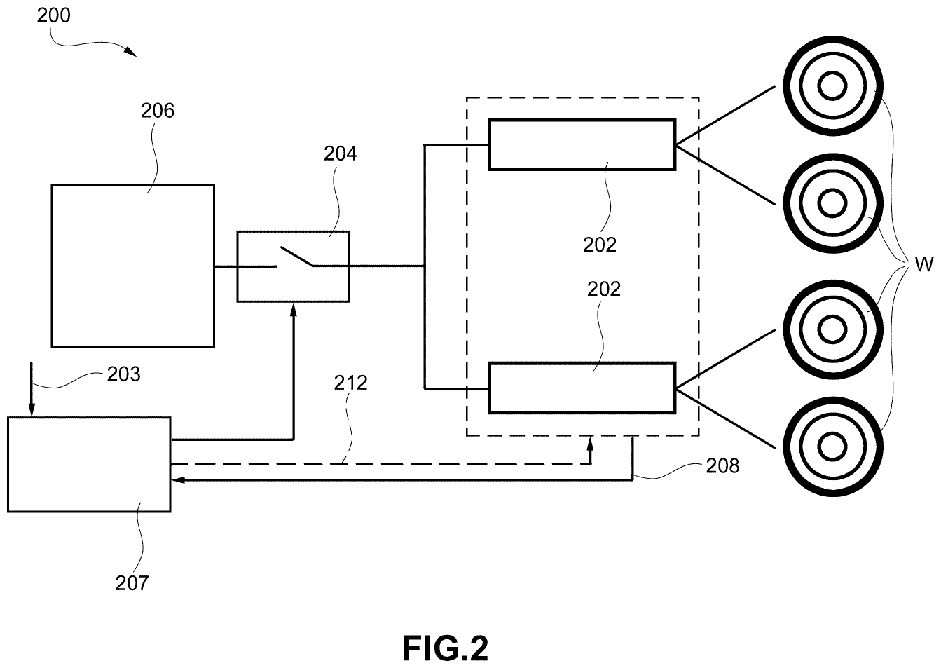

Turning now to FIG. 2, this figure shows an embodiment of a braking control system 200 for a vehicle system having at least one vehicle, e.g., at least one railway vehicle. The vehicle system includes an electrodynamic braking system 202, a pneumatic braking system (not shown in the figures), an electrical power system 206, and, in some embodiments, a connection device 204.

The connection device 204 is configured to be controllable to assume at least two conditions: a first condition adapted to enable the flow of electrical energy between the electrical power system 206 and the electrodynamic braking system 202; and a second condition adapted to prevent the flow of electrical energy between the electrical power system 206 and the electrodynamic braking system 202.

The braking control system 200 includes a first control circuit 207. The first control circuit 207 is configured, responsive to when it receives an emergency braking request signal 203 indicative of a request for the application of an emergency braking force having an emergency braking force target value, to switch the connection device 204 into the first condition adapted to enable the flow of electrical energy between the electrical power system 206 and the electrodynamic braking system 202, for the generation of an emergency electrodynamic braking force through the electrodynamic braking system 202.

In other words, when it is necessary to carry out emergency braking with a braking force having the emergency braking force target value, the first control circuit 207 may switch the connection device 204 into the first condition, so that (i) the electrical energy is supplied from the electrical power system 206 to the electrodynamic braking system 202, which may use the received electrical energy to generate an emergency electrodynamic braking force, or (ii) the electrical energy is transferred from the electrodynamic braking system 202 to the electrical power system 206, in situations where the electrodynamic braking system generates electrical power from producing an emergency electrodynamic braking force (e.g., in embodiments where the electrodynamic braking system includes traction motors of the vehicle system that are controlled to operate as generators, instead of as motors, in a regenerative or dynamic braking mode of operation).

Emergency electrodynamic braking force may refer, for example, to the maximum electrodynamic braking force that may be applied by the electrodynamic braking system to attempt to meet the emergency braking request.

In embodiments, the first control circuit 207 is also configured to receive an electrodynamic braking force signal 208 indicating an electrodynamic braking force value applied by the electrodynamic braking system. Responsive to when the electrodynamic braking force signal 208 indicates an electrodynamic braking force value less than the emergency braking force target value, the first control circuit 207 is configured to activate the pneumatic braking system to generate an additional pneumatic braking force. This additional pneumatic braking force is configured to compensate for the difference in braking force between the emergency braking force target value and the electrodynamic braking force value indicated by the electrodynamic braking force signal 208.

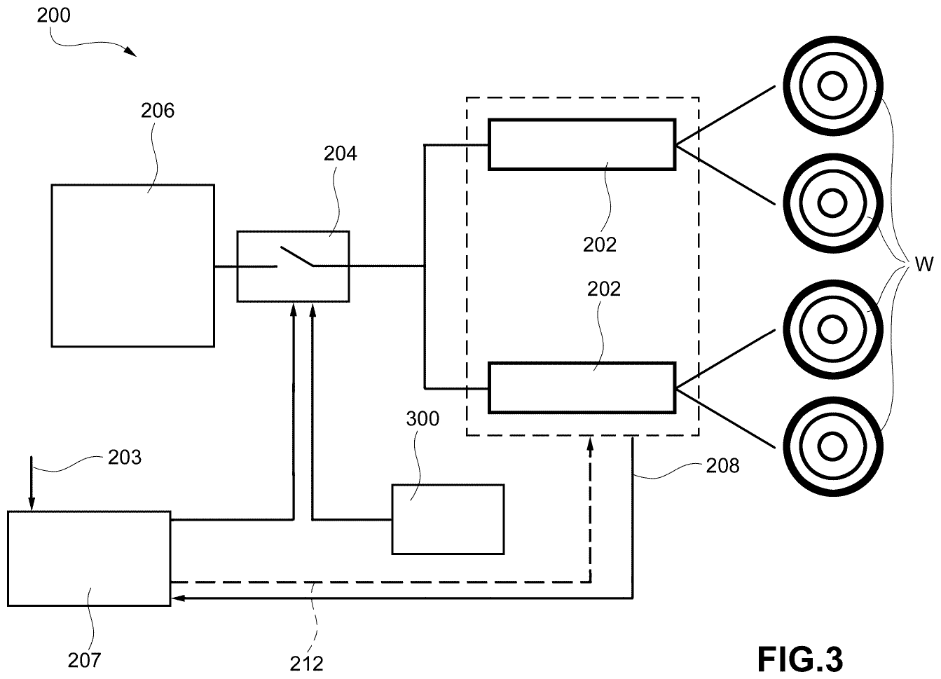

In embodiments, with reference to FIG. 3, the braking control system 200 may also include a second control circuit 300. This second control circuit 300 may also be configured to switch the connection device 204 from the first condition to the second condition responsive to when it determines that there is a failure of the electrodynamic braking system 202; and/or to when it determines that there is a failure of the electrical power system 206. For example, the second control circuit 300 may be a control circuit for vehicle management.

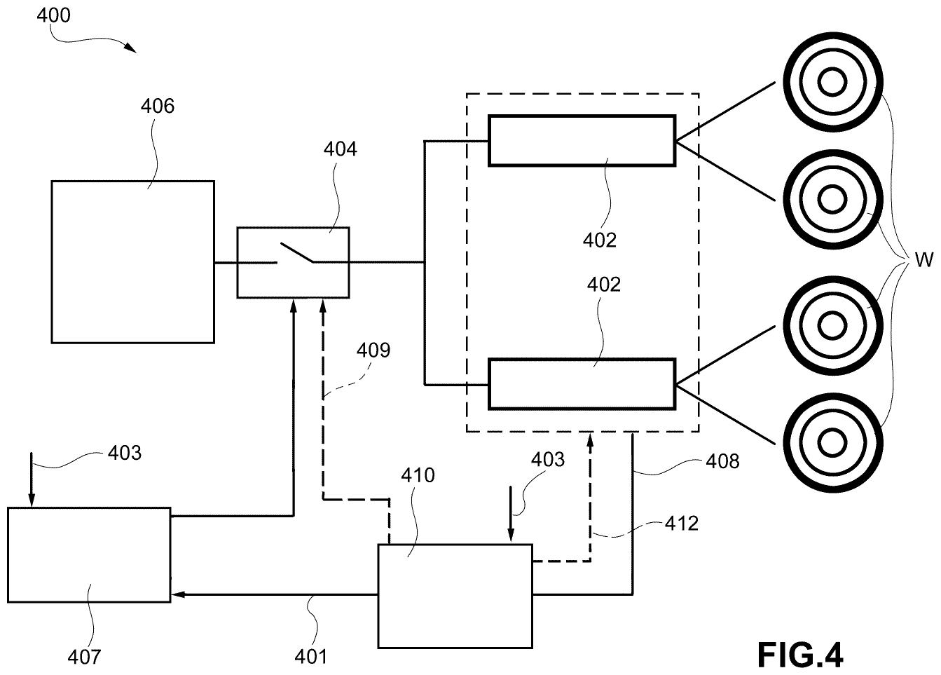

Referring to FIG. 4, an additional embodiment of a braking control system 400 for a vehicle system having at least one vehicle, e.g., at least one railway vehicle, is described below. As with the preceding embodiments, the vehicle system includes an electrodynamic braking system 402, a pneumatic braking system, an electrical power system 406, and a connection device 404. The connection device 404 is configured to assume a first condition that enables the flow of electrical energy between the electrical power system 406 and the electrodynamic braking system 402 and to assume a second condition that prevents the flow of electrical energy between the electrical power system 406 and the electrodynamic braking system 402.

In this embodiment, the braking control system includes a first control circuit 407 and a second control circuit 410. The second control circuit 410 is configured to receive an emergency braking request signal 403 indicative of a request for the application of an emergency braking force having an emergency braking force target value. The second control circuit 410 is further configured to receive an electrodynamic braking force signal 408 indicative of an electrodynamic braking force value applied by the electrodynamic braking system 402. The second control circuit 410 is further configured to determine an additional pneumatic braking force value necessary to compensate for any difference between the emergency braking force target value and the applied electrodynamic braking force value indicated by the electrodynamic braking force signal 408, and to transmit to the first control circuit 407 an additional pneumatic braking force signal 401 indicative of the determined additional pneumatic braking force value.

In this embodiment, the first control circuit 407 is configured, responsive to when it receives the emergency braking request signal 403 indicative of the request for the application of an emergency braking force having the emergency braking force target value, to switch the connection device 404 into the first condition adapted to enable the flow of electrical energy between the electrical power system 406 and the electrodynamic braking system 402, for generating an emergency electrodynamic braking force through the electrodynamic braking system 402. The first control circuit 407 is further configured to receive the additional pneumatic braking force signal from the second control circuit 410, and to activate the pneumatic braking system to generate a pneumatic braking force having the additional pneumatic braking force value indicated by the additional pneumatic braking force signal 401.

In other words, the first control circuit 407 does not directly receive the electrodynamic braking force signal 408 indicative of an electrodynamic braking force value applied by the electrodynamic braking system 402. The electrodynamic braking force signal 408 is received by the second control circuit 410, which will determine the additional pneumatic braking force value required.

For all the previously described embodiments, according to one aspect, the first control circuit 207, 407 may also be configured, during the application of the emergency electrodynamic braking force by the electrodynamic braking system 202, 402, to determine a vehicle deceleration value. Responsive to when the determined vehicle deceleration value is less than a vehicle deceleration target value, the first control circuit 207, 407 may be configured to switch the connection device 204, 404 into the second condition adapted to prevent the flow of electrical energy between the electrical power system 206, 406 and the electrodynamic braking system 202, 402. Furthermore, the first control circuit 207, 407 may be configured to activate the pneumatic braking system to generate an emergency pneumatic braking force having a value equal to or greater than the emergency braking force target value.

Emergency pneumatic braking force may be understood, for example, to mean a pneumatic braking force that meets or surpasses the emergency braking force target value.

In other words, in observing the vehicle's deceleration, if the first control circuit 207, 407 determines that emergency braking cannot be sufficiently achieved even with additional pneumatic force, the first control circuit 207, 407 may de-energize the electrodynamic braking system 202, 402 and activate the pneumatic braking system, so that the pneumatic braking system is directly responsible for performing the emergency braking, thereby ensuring that the emergency braking is always performed safely.

In embodiments, the second control circuit 410 may also be configured to switch the connection device 404 from the first condition to the second condition (e.g., via the dotted command line 409 shown in FIG. 4) responsive to when it determines that there is a failure of the electrodynamic braking system 202, 402, and/or responsive to when it determines that there is a failure of the electrical power system 206, 406.

Also in this case, the second control circuit 410 may, for example, be a control circuit for vehicle management.

If the first control circuit 207, 407 and the second control circuit 410 (or the second control circuit 300) were to give opposite commands to the connection device 204, 404, i.e., one commanding the opening of the connection device 204, 404 and the other commanding the closing of the connection device 204, 404, priority may be given to the command to open the connection device 204, 404, to ensure that the safety system always operates in the safest condition.

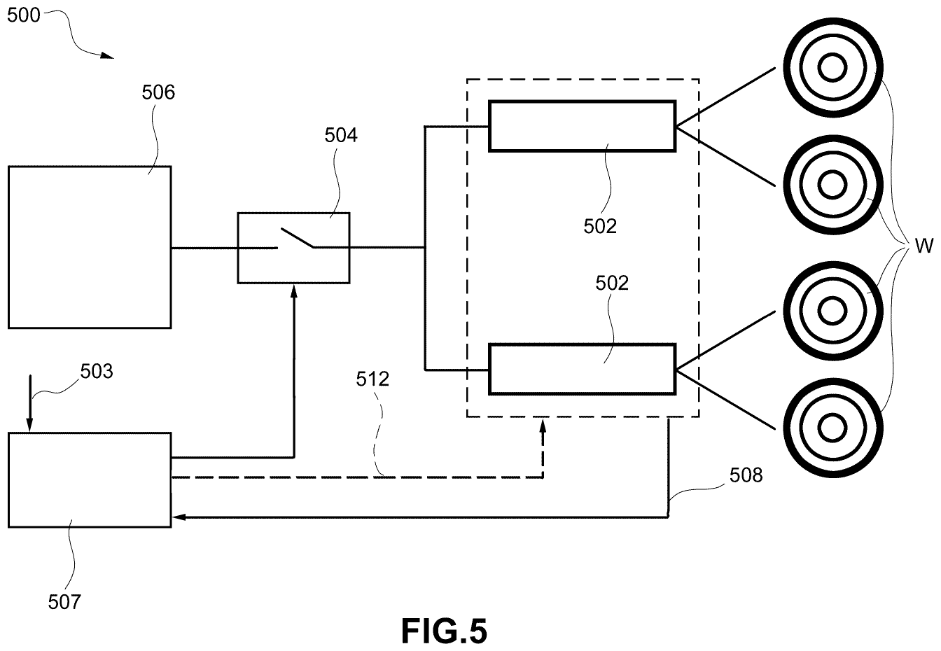

In the following, a still further embodiment of a braking control system 500 for a vehicle system having at least one vehicle, particularly at least one railway vehicle, is described. In this case, reference may be made to FIG. 5. FIG. 2 and the FIG. 5 show similar structures. Also in this embodiment, the vehicle system includes the electrodynamic braking system 502, the pneumatic braking system, the electrical power system 506, and the connection device 504. The connection device is again controllable to assume a first condition adapted to enable the flow of electrical energy between the electrical power system 506 and the electrodynamic braking system 502, and to assume a second condition designed to prevent the flow of electrical energy between the electrical power system 506 and the electrodynamic braking system 502.

Also in this embodiment, the braking control system 500 comprises a first control circuit 507 configured, responsive to when it receives an emergency braking request signal 503 indicative of a request for the application of an emergency braking force having an emergency braking force target value, to switch the connection device 504 into the first condition adapted to enable the flow of electrical energy between the electrical power system 506 and the electrodynamic braking system 502, for the generation of an emergency electrodynamic braking force through the electrodynamic braking system 502.

The first control circuit 507, however, during the application of the emergency electrodynamic braking force by the electrodynamic braking system 502, is configured to determine a vehicle deceleration value. Responsive to when the determined vehicle deceleration value is less than a vehicle deceleration target value, the first control circuit 507 is configured to switch the connection device 504 into the second condition adapted to prevent the flow of electrical energy between the electrical power system 506 and the electrodynamic braking system 502. Furthermore, the first control circuit 507 is configured to activate the pneumatic braking system to generate an emergency pneumatic braking force having a value equal to or greater than the emergency braking force target value.

In other words, in observing the vehicle's deceleration, if the first control circuit 507 determines that the emergency braking cannot be sufficiently achieved with the electrodynamic force, without utilizing the option of applying additional pneumatic braking, the first control circuit 507 may immediately de-energize the electrodynamic braking system 502 and activate the pneumatic braking system, so that the pneumatic braking system is directly responsible for performing the emergency braking immediately, thereby ensuring that emergency braking is always performed safely.

In aspects, also in this embodiment, the first control circuit 507 may receive an electrodynamic braking force signal 508 indicative of an electrodynamic braking force value applied by the electrodynamic braking system 502, if necessary.

In embodiments, the braking control system 500 could include a second control circuit (not shown in the figures and substantially equivalent to the second control circuit 300 shown in FIG. 2). This second control circuit may also be configured to switch the connection device 504 from the first condition to the second condition responsive to when it determines that there is a failure of the electrodynamic braking system 502, and/or responsive to when it determines that there is a failure of the electrical power system 506.

The features described below may apply to all the embodiments described.

The electrodynamic braking system 202, 402, 502 may include any braking means capable of generating an electrodynamic braking force, and pneumatic braking system may be understood as meaning any braking means capable of generating a pneumatic braking force.

For example, the first control circuit 207, 407, in order to determine a deceleration value of the vehicle, may receive the deceleration value directly or a signal indicative of the deceleration value from an acceleration sensor or a speed sensor.

For example, the first control circuit 207, 407, and/or the second control circuit 410 when provided, in order to determine the electrodynamic braking force value applied by the electrodynamic braking system, may receive the applied electrodynamic braking force value directly or a signal indicative of the applied electrodynamic braking force value that is generated by a force sensor or directly generated by the electrodynamic braking system(s).

In embodiments, the electrical power system 206, 406, 506 may be a pantograph. In this case, the pantograph may be configured to be installed on the vehicle and to be connected with a power line when it needs to draw electrical energy from the power line. Alternatively, In embodiments, the electrical power system 206, 406, 506 may be an electrical contact means configured to be installed on the vehicle and connected with a third rail when it needs to draw electrical energy from the third rail. The third rail is a well-known system used for supplying electrical energy to, for example, railway vehicles or mass transit systems. In a further alternative, the electrical power system 206, 406, 506 may be an electrical energy generation system configured to generate electrical energy by converting the mechanical energy produced by the vehicle's combustion engine. In other embodiments, the electrical power system may alternatively or additionally include an energy storage device (e.g., array of batteries) and/or a resistive grid configured to dissipate electrical power as waste heat.

In embodiments, the connection device 204, 404, 504 may be a relay. In particular, to keep the overall safety level of the braking system high, the relay used may be a safety relay. Alternatively, the connection device 204, 404, 504 may comprise one or more components configured to enable or prevent the flow of electric power from upstream to downstream of the connection device 204, 404, 504, such as controlled solid-state devices (e.g., power transistors) or other switches.

In embodiments, the electrodynamic braking system 202, 402, 502 may include at least one electric motor. For example, an electric motor used for vehicle traction may also be reused in braking as an electric generator for generating an electrodynamic braking force.

Regarding the pneumatic braking system, it may include at least one pneumatic braking cylinder configured to receive a brake fluid (e.g., compressed air) from the vehicle system's pneumatic pipe. As explained for the prior art, the pneumatic braking system, through compressed air acting on pistons housed in brake cylinders, are capable of applying a braking force. The braking force may be provided, for example, by friction pads driven by the pneumatic pistons. The pneumatic braking force may be applied through the use of friction elements, which make use of the frictional force between surfaces to ensure that the vehicle stops. The contact surfaces may be, for example, elements on which a friction material is applied, known as brake pads, driven by the pneumatic pistons, and circular elements known as brake discs, attached to the wheels W or wheel axles of the vehicle. The contact surfaces may also be the brake pads, driven by the pneumatic pistons, and the wheels W of the vehicle.

In embodiments, the first control circuit 207, 407, 507 and/or the connection device 204, 404, 504 may be obtained according to a safety integrity level, SIL, equal to the safety integrity level with which the emergency braking is managed.

In embodiments, the electrodynamic braking system 202, 402, 502 may instead be designed with a lower safety integrity level than the safety integrity level with which emergency braking is managed.

When the vehicle system includes vehicles in the railway sector, with regard to the definition of the safety integrity level SIL, reference may be made to European standards EN50129: rev.2018, EN 50126-1: rev.2017, EN 50126-2: rev.2017, EN 50128: rev.2011, according to the latest update available on the filing date of the present invention, where:
EN50126 [“Railway applications. The specification and demonstration of reliability, availability, maintainability and safety (RAMS)];
EN50128 [“Railway applications. Communications, signalling and processing systems. Software for railway control and protection systems”];
EN50129 [“Railway applications. Communication, signaling and processing systems. Safety related electronic systems for signalling”].

In particular, standard EN50126 defines the methodologies for assigning the SILO/1/2/3/4 safety levels (with safety integrity level SIL4 indicating the maximum safety integrity level) to the subsystems making up the system in question, based on the results of the safety analysis, and standards EN50128 and EN50129 define the design criteria to be applied to the software and hardware components, respectively, based on the SIL levels assigned based on the safety analysis results. A control circuit, a device, a unit or module, etc., may be considered implemented according to a high safety integrity level when made at least according to a SIL>=3 safety integrity level. In embodiments, the first control circuit 207, 407, 507 of the braking control system 200, 400, 500 of the present invention may be obtained according to a safety integrity level greater than 3, e.g. SIL=4 (SIL=3 may be considered the predetermined minimum safety integrity level).

The connection device 204, 404, 504 may also, in embodiments, be obtained according to a safety integrity level greater than 3, e.g. SIL=4.

In embodiments, for embodiments that do not include the second control circuit 410, the first control circuit 207, 507 may be configured to transmit to the electrodynamic braking system a requested emergency electrodynamic braking force signal 212, 512, the value of which is indicative of the emergency electrodynamic braking force value to be applied by the electrodynamic braking system. The value of the requested electrodynamic emergency braking force signal 212, 512 may be determined by the first control circuit 207, 507, depending on the emergency braking force target value and/or a maximum electrodynamic braking force value applicable by the electrodynamic braking system. The maximum applicable electrodynamic braking force value may be determined according to a predetermined braking characteristic/mapping of the electrodynamic braking system that relates a vehicle travel speed and the maximum electrodynamic braking force value applicable by the electrodynamic braking system.

In embodiments, for embodiments that include the second control circuit 410, the second control circuit 410 may be configured to transmit to the electrodynamic braking system a requested emergency electrodynamic braking force signal 412, the value of which is indicative of the emergency electrodynamic braking force value to be applied by the electrodynamic braking system. The value of the requested electrodynamic emergency braking force signal 412 may be determined by the second control circuit 410, depending on the emergency braking force target value and/or a maximum electrodynamic braking force value applicable by the electrodynamic braking system. The maximum applicable electrodynamic braking force value may be determined according to a braking characteristic/mapping of the electrodynamic braking system that relates a vehicle travel speed and the maximum electrodynamic braking force value applicable by the electrodynamic braking system.

In another aspect, embodiments of the invention concern a vehicle system having at least one vehicle, e.g., at least one railway vehicle. This vehicle system comprises a braking control system 200, 400, 500 according to any of the previously described embodiments.

In a still further aspect, embodiments of the invention relate to a braking control method for at least one vehicle, particularly at least one railway vehicle. In this embodiment, the braking control method includes the steps of:
receiving an emergency braking request signal 203, 403 indicative of a request for the application of an emergency braking force having an emergency braking force target value;
subsequent to the receipt of the emergency braking request signal 203, 403 indicative of the request for the application of the emergency braking force, switching a connection device 204, 404 into a first condition adapted to enable the flow of electrical energy between an electrical power system 206, 406 and the electrodynamic braking system 202, 402, for the generation of an emergency electrodynamic braking force by the electrodynamic braking system;
determining an electrodynamic braking force value applied by the electrodynamic braking system; and
when the electrodynamic braking force value is less than the emergency braking force target value, activating a pneumatic braking system to generate an additional pneumatic braking force configured to compensate for the difference in braking force between the emergency braking force target value and the electrodynamic braking force value indicated by the electrodynamic braking force signal.

The braking control method may, in embodiments, also include the steps of:
during the application of the emergency electrodynamic braking force by the electrodynamic braking system 202, 402, determining a vehicle deceleration value;
if the determined vehicle deceleration value is less than a vehicle deceleration target value, switching the connection device 204, 404 into the second condition adapted to prevent the flow of electrical energy between the electrical power system 206, 406 and the electrodynamic braking system 202, 402; and
activating the pneumatic braking system for the generation of an emergency pneumatic braking force having a value equal to or greater than the emergency braking force target value.

In an additional possible embodiment of a braking control method for at least one vehicle, particularly at least one railway vehicle, the braking control method includes the steps of:
receiving an emergency braking request signal 503 indicative of a request for the application of an emergency braking force having an emergency braking force target value;
subsequent to the receipt of the emergency braking request signal 503 indicative of the request for the application of the emergency braking force, switching a connection device 504 into a first condition adapted to enable the flow of electrical energy between an electrical power system 506 and an electrodynamic braking system 502, for the generation of an emergency electrodynamic braking force by the electrodynamic braking system;
during the application of the emergency electrodynamic braking force by the electrodynamic braking system 502, determining a vehicle deceleration value;
if the determined vehicle deceleration value is less than a vehicle deceleration target value, switching the connection device 504 into a second condition adapted to prevent the flow of electrical energy between the electrical power system 506 and the electrodynamic braking system 502 and activating the pneumatic braking system to generate an emergency pneumatic braking force having a value equal to or greater than the emergency braking force target value.

In embodiments, the vehicle system may be a railway vehicle or a railway convoy (or train) having a plurality of railway vehicles. For example, multiple vehicles may be connected or associated with each other to form a convoy. In embodiments, the present invention may be particularly applicable to the field of railway vehicles/trains that travel on railway tracks. For example, a vehicle system referred to herein may be a locomotive or a wagon, and a route/section may include rails on which the wheels of the locomotive roll. However, the embodiments described herein are not intended to be limited to vehicles on tracks. For example, the vehicle system may be a car, a truck (for example a highway semi-trailer truck, a mining truck, a truck for transporting timber or the like) or the like, and the route may be a road or a trail.

Thus, an advantage that may be achieved by embodiments of the invention is to provide braking control systems, braking control methods, and a vehicle system that: solve the previously described drawbacks regarding the difficulties of using the electrodynamic braking system during emergency braking; do not provide for the well-known but costly option of modifying the design of the electrodynamic braking system; and/or make it possible to use, during emergency braking, the electrodynamic braking system without any modification thereto.

Embodiments may be described in connection with a rail vehicle system, such as a locomotive or switcher, or other types of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

Movement of a vehicle system may include propelling the vehicle forward or backward along a direction of travel, as well as slowing or stopping the vehicle. Movement further may include turning left or right, and increasing or decreasing elevation or depth. Movement further may include determining or setting a vehicle speed, changing a vehicle speed, and matching speeds and directions between vehicles in a vehicle group. Indirectly, movement of the vehicle may include ramping up (or down) power sources; and this may include energizing electrical circuits or buses, setting fuel flow rates, setting engine RPM rates, and the like.

The terms “control circuit” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features can be stored in various types of memory. Suitable memory may include dynamic random-access memory (DRAM), flash memory, and/or cache. These instructions can be distributed over a network or via other computer-readable media. The term “non-transitory computer-readable medium” refers to any physical medium capable of storing or transmitting instructions or information that can be read by a machine. Examples of suitable media include RAM, ROM, EPROM, EEPROM, magnetic or optical media, flash memory, or even propagated signals such as carrier waves or infrared signals.

In some embodiments, the control circuit can utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model or a good-enough model may be selected, and the control circuit can execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. raw data gathered by these sensors may feed into the control circuit, which in turn can respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A braking control system for a vehicle system, comprising:
a first control circuit configured for operable connection to the vehicle system, wherein the first control circuit is further configured to:
responsive to receiving an emergency braking request signal indicative of a request for the application of an emergency braking force having an emergency braking force target value, control an electrodynamic braking system of the vehicle system for the generation of an emergency electrodynamic braking force through the electrodynamic braking system;
receive an electrodynamic braking force signal indicative of an electrodynamic braking force value applied by the electrodynamic braking system; and
responsive to when the electrodynamic braking force signal indicates an electrodynamic braking force value less than the emergency braking force target value, control activation of a pneumatic braking system of the vehicle system to generate an additional pneumatic braking force configured to compensate for the difference in braking force between the emergency braking force target value and the electrodynamic braking force value indicated by the electrodynamic braking force signal.

2. The braking control system of claim 1, further comprising a second control circuit configured for operable connection to the vehicle system,
wherein the second control circuit is configured to control deactivation of the electrodynamic braking system from emergency braking, responsive to:
when the second control circuit determines that there is a failure of the electrodynamic braking system; and/or
when the second control circuit determines that there is a failure of an electrical power system connected to the electrodynamic braking system.

3. The braking control system of claim 2, wherein the first control circuit is further configured to:
during the application of the emergency electrodynamic braking force by the electrodynamic braking system, determine a vehicle deceleration value;
responsive to when the determined vehicle deceleration value is less than a target vehicle deceleration value, control deactivation of the electrodynamic braking system from emergency braking; and
activate the pneumatic braking system for the generation of an emergency pneumatic braking force having a value equal to or greater than the emergency braking force target value.

4. The braking control system of claim 1, wherein the first control circuit is configured to control the electrodynamic braking system for the generation of the emergency electrodynamic braking force through the electrodynamic braking system, responsive to receiving the emergency braking request signal, by switching a connection device of the vehicle system from a second condition, configured to prevent the flow of electrical energy between an electrical power system of the vehicle system and the electrodynamic braking system, to a first condition configured to enable the flow of the electrical energy between the electrical power system and the electrodynamic braking system.

5. The braking control system of claim 4, wherein the second control circuit is further configured to switch the connection device from the first condition to the second condition responsive to:
when the second control circuit determines that there is a failure of the electrodynamic braking system; and/or
when the second control circuit determines that there is a failure of the electrical power system.

6. The braking control system of claim 4, wherein the first control circuit is further configured to:
during the application of the emergency electrodynamic braking force by the electrodynamic braking system, determine a vehicle deceleration value;
responsive to when the determined vehicle deceleration value is less than a target vehicle deceleration value, switch the connection device into the second condition adapted to prevent the flow of electrical energy between the electrical power system and the electrodynamic braking system; and
activate the pneumatic braking system for the generation of an emergency pneumatic braking force having a value equal to or greater than the emergency braking force target value.

7. The braking control system of claim 4, wherein the first control circuit and/or the connection device are implemented according to a safety integrity level equal to the safety integrity level with which the emergency braking is managed;
and/or
wherein the electrodynamic braking system is realized according to a safety integrity level lower than the safety integrity level with which emergency braking is managed.

8. The braking control system of claim 4, wherein the connection device comprises a relay and the electrodynamic braking system comprises at least one electric motor.

9. The braking control system of claim 1, wherein the first control circuit is further configured to:
during the application of the emergency electrodynamic braking force by the electrodynamic braking system, determine a vehicle deceleration value;
responsive to when the determined vehicle deceleration value is less than a target vehicle deceleration value, control deactivation of the electrodynamic braking system from emergency braking; and
activate the pneumatic braking system for the generation of an emergency pneumatic braking force having a value equal to or greater than the emergency braking force target value.

10. The braking control system of claim 1, wherein the first control circuit is configured to transmit to the electrodynamic braking system a requested emergency electrodynamic braking force signal whose value is indicative of the emergency electrodynamic braking force value to be applied by the electrodynamic braking system;
wherein the value of the requested emergency electrodynamic braking force signal is determined by the first control circuit, according to the emergency braking force target value and/or a maximum electrodynamic braking force value applicable by the electrodynamic braking system; and
wherein the maximum applicable electrodynamic braking force value is determined according to a braking characteristic of the electrodynamic braking system that relates a vehicle travel speed and the maximum electrodynamic braking force value applicable by the electrodynamic braking system.

11. A braking control system for a vehicle system, comprising:
a first control circuit and a second control circuit both configured for operable connection to the vehicle system, wherein the second control circuit is further configured to:
receive an emergency braking request signal indicative of a request for the application of an emergency braking force having an emergency braking force target value;
receive an electrodynamic braking force signal indicative of an electrodynamic braking force value applied by an electrodynamic braking system of the vehicle system;
determine an additional pneumatic braking force value necessary to compensate for a difference between the emergency braking force target value and the applied electrodynamic braking force value indicated by the electrodynamic braking force signal; and
transmit to the first control circuit an additional pneumatic braking force signal indicative of the determined additional pneumatic braking force value;
and wherein the first control circuit is further configured to:
responsive to receiving the emergency braking request signal indicative of the request for the application of the emergency braking force having the emergency braking force target value, control the electrodynamic braking system for the generation of an emergency electrodynamic braking force through the electrodynamic braking system;
receive the additional pneumatic braking force signal from the second control circuit; and
control a pneumatic braking system of the vehicle system to generate a pneumatic braking force having the additional pneumatic braking force value indicated by the additional pneumatic braking force signal.

12. The braking control system of claim 11, wherein the first control circuit is configured to control the electrodynamic braking system for the generation of the emergency electrodynamic braking force, responsive to receiving the emergency braking request signal, by switching a connection device of the vehicle system from a second condition, configured to prevent the flow of electrical energy between an electrical power system of the vehicle system and the electrodynamic braking system, to a first condition configured to enable the flow of the electrical energy between the electrical power system and the electrodynamic braking system.

13. The braking control system of claim 12, wherein the second control circuit is also configured to switch the connection device from the first condition to the second condition responsive to:
when the second control circuit determines that there is a failure of the electrodynamic braking system; and/or
when the second control circuit determines that there is a failure of the electrical power system.

14. The braking control system of claim 12, wherein the first control circuit is further configured to:
during the application of the emergency electrodynamic braking force by the electrodynamic braking system, determine a vehicle deceleration value;
responsive to when the determined vehicle deceleration value is less than a target vehicle deceleration value, switch the connection device into the second condition configured to prevent the flow of electrical energy between the electrical power system and the electrodynamic braking system; and
activate the pneumatic braking system for the generation of an emergency pneumatic braking force having a value equal to or greater than the emergency braking force target value.

15. The braking control system of claim 14, wherein the connection device comprises a relay and the electrodynamic braking system comprises at least one electric motor.

16. The braking control system of claim 11, wherein the first control circuit is further configured to:
during the application of the emergency electrodynamic braking force by the electrodynamic braking system, determine a vehicle deceleration value;
responsive to when the determined vehicle deceleration value is less than a target vehicle deceleration value, control deactivation of the electrodynamic braking system from emergency braking; and
activate the pneumatic braking system for the generation of an emergency pneumatic braking force having a value equal to or greater than the emergency braking force target value.

17. The braking control system of claim 11, wherein the first control circuit is configured to transmit to the electrodynamic braking system a requested emergency electrodynamic braking force signal whose value is indicative of the emergency electrodynamic braking force value to be applied by the electrodynamic braking system;
wherein the value of the requested emergency electrodynamic braking force signal is determined by the first control circuit, according to the emergency braking force target value and/or a maximum electrodynamic braking force value applicable by the electrodynamic braking system; and
wherein the maximum applicable electrodynamic braking force value is determined according to a braking characteristic of the electrodynamic braking system that relates a vehicle travel speed and the maximum electrodynamic braking force value applicable by the electrodynamic braking system.

18. A braking control system for a vehicle system, comprising:
a first control circuit configured for operable connection to the vehicle system, wherein the first control circuit is further configured to:
responsive to when the first control circuit receives an emergency braking request signal indicative of a request for the application of an emergency braking force having an emergency braking force target value, switch a connection device of the vehicle system into a first condition configured to enable the flow of electrical energy between an electrical power system and an electrodynamic braking system of the vehicle system, for the generation of an electrodynamic emergency braking force through the electrodynamic braking system;
during the application of the emergency electrodynamic braking force by the electrodynamic braking system, determine a vehicle deceleration value;
responsive to the determined vehicle deceleration value being less than a vehicle deceleration target value, switch the connection device into a second condition configured to prevent the flow of electrical energy between the electrical power system and the electrodynamic braking system; and
activate a pneumatic braking system of the vehicle system for the generation of an emergency pneumatic braking force having a value equal to or greater than the emergency braking force target value.

19. The braking control system of claim 18, wherein the electrical power system comprises at least one of: a pantograph configured to be installed on the vehicle system and to be brought into contact with a power line for drawing electrical energy from the power line; an electrical contactor configured to be installed on the vehicle system and to be brought into contact with a third rail for drawing electrical energy from the third rail; an electrical energy generation system configured to generate electrical energy by conversion of mechanical energy generated by a combustion engine of the vehicle system; an energy storage device; and/or a resistive grid configured to dissipate electrical power as waste heat.

20. The braking control system of claim 18, wherein the first control circuit is configured to transmit to the electrodynamic braking system a requested emergency electrodynamic braking force signal whose value is indicative of the emergency electrodynamic braking force value to be applied by the electrodynamic braking system;
wherein the value of the requested emergency electrodynamic braking force signal is determined by the first control circuit, according to the emergency braking force target value and/or a maximum electrodynamic braking force value applicable by the electrodynamic braking system; and
wherein the maximum applicable electrodynamic braking force value is determined according to a braking characteristic of the electrodynamic braking system that relates a vehicle travel speed and the maximum electrodynamic braking force value applicable by the electrodynamic braking system.
